(19) United States
(12) Patent Application Publication
(10) Pub. No.: US 2011/0035329 A1
(43) Pub. Date: Feb. 10, 2011

(54) Search Methods and Systems Utilizing Social Graphs as Filters

(76) Inventors: James W. Delli Santi, San Jose, CA (US); Michael McConachie, Long Grove, IL (US)

Correspondence Address: CARR & FERRELL LLP, 120 CONSTITUTION DRIVE, MENLO PARK, CA, 94025, US

(21) Appl. No.: 12/727,172

(22) Filed: Mar. 18, 2010

Related U.S. Application Data
(60) Provisional application No. 61/232,378, filed on Aug. 7, 2009.

(51) Int. Cl. G06Q 99/00; G06F 17/30

(52) U.S. Cl. 705/347; 707/769; 707/E17.014; 707/E17.108

(57) ABSTRACT

A search method and system that accesses a preference data base established by users of the system. The users may not be required to rate businesses they enter into the data base. The entry of the business into the data base constitutes an endorsement of (a “vote” for) the business. A searching party may establish a social filter to narrow the focus of searches performed.

### CROSS-REFERENCE TO RELATED APPLICATIONS

This application claims benefit of U.S. provisional application Ser. No. 61/232,378, filed Aug. 7, 2009, entitled “Search Method to Identify Local Entities of Interest Utilizing Social Graphs as Filters”, which is incorporated herein by reference.

### BACKGROUND OF THE INVENTION

1. Field of the Invention

The present invention relates generally to a search engine. The invention relates more particularly to providing localized search results based on social graph inputs.

2. Background Art

Since the Internet was launched in 1995, online services have emerged for many consumer and business needs and applications. The power of the Internet has been attributed to its unique properties as a global, two-way medium that allows any user the ability to reach global users or businesses and interact with them, literally at the speed of light. The term “globalization” has become the new order of the economic day, powerfully enabled by the Internet, which has caused massive shifts and transformations in how consumers and businesses conduct their day-to-day personal and commercial business.

In today's “information age” people frequently perform various types of searches using computing devices connected to the Internet. The Internet has made searching for information far more simple than using manual techniques, which typically involve going to a library and searching through various indexes to find articles or books, for example. To perform a computerized search, a searcher simply enters a word or words (termed “keywords”) into a website query box in order to find information related to the entered words. The website providing the query box uses a search engine to scrutinize billions of documents on the Internet and return documents including the keywords entered by the searcher.

Search engines are widely utilized over networks for locating the information sought by the user. Conventional search engines employ keyword matching in order to select candidate web page links to return to the user seeking data related to the keywords in the entered query. The page links are then ranked and displayed according to results from complex algorithms that determine relevance and in the case of advertising balance relevance with revenue to determine which links to present and in which order. The algorithms use a combination of link citations, click through rate, price per click, number of keywords matched, order of keywords matched, and many other factors to determine the ranking of search results returned.

Unfortunately, for a consumer who is in the market to purchase a product or service quickly, one that matches his/her personal preferences, values or budget, the typical search or local search engine can return far too many documents in response to a buyer's needs resulting in information overload. Often this is because results are returned using keywords that could have many types of meaning. The keyword and location matching alone can produce documents for a search with local intent that are completely out of context from the context of local shopping and purchasing, or the keywords in the document from the results may be related to non-relevant, research-oriented subjects and types of web content. Another source of misdirection is that the most relevant web pages containing the keywords may be popular for reasons unrelated to the local shopping and purchasing. Of the hundreds or thousands of links to supposedly related web pages returned to the user, in the context of searching for local products and services it is hard for consumers to choose which of the local products and services being presented are right for them or will meet their immediate need. For example, when a consumer needs a local dentist fast, they typically only need 2-3 highly recommended dentists.

Even the web page matches that are relevant to the user's search may not prove to be useful. The lack of utility is often due to a local of personal relevance. Although approximately half of United States commerce takes place within ten miles of a the principal's home or work location, an Internet user still has a very hard time finding a high quality local service that matches his specific needs, values, or budget. It is very difficult for a user of conventional search engines, to find a personally relevant product or service on the Internet, in the roughly one minute that consumers take to look up services in the Yellow Pages or to find an ad in the weekly advertising circulars of newspapers or direct mailings.

In an effort to increase the relevancy of search engine results, local web search service providers provide topically relevant and geographically relevant search results using “explicitly-entered” keywords, categories, and geographies. In these solutions, consumers explicitly enter the categories/keywords and geography of their intended purchase, and small and medium business listings from merchant directories are matched against these categories and geographies to provide search results with local and topical relevance. The listings that are returned in response to this type of search query match the categories entered by the user, and are ranked in order of proximity to the user's explicitly declared location or to an implicitly derived (via the search software) location. However, the user may still receive far more business listings than prove useful (most users are looking for 2-3 possibilities). Again prior art search engine techniques require the searcher to research and read through a lot of information such as detailed information, reviews and ratings to make a quality decision among 1-3 businesses that are right for him.

Another method implemented in some prior art search engines it to provide a ranking algorithm based on pay-for-position. That is, local businesses that pay the most advertising dollars secure the most visibility in the search results. A drawback to this methodology is that advertisers, by their expenditures of advertising dollars, control the user's search results. Worse, the local businesses listed returned may not have any personal relevancy and may simply not be qualified to the satisfaction of the user. Any or all of the listed businesses may or may not provide the kind of services that meet the needs, budgets, or expectations for quality of service of any given search engine user.

At least in part due to the limited local and personal relevance and local value offered through today's local online solutions, only a small fraction of advertising expenditures have migrated from local offline promotion and direct mail advertising to the Internet. Therefore, there is a need for a local recommendation service that returns search local businesses similar to the way it happens in the offline world, via word of mouth from trusted friends, family and colleagues or neighbors.

### SUMMARY OF THE INVENTION

The present invention includes methods and systems for performing computer based searches utilizing social graphs as filters. The system allows users to search a data base that is maintained in real time for businesses that meet the search criteria for subject matter and geographic area. The resulting candidate businesses may be further filtered using a social graph designated by the searching party. The social graph may include varying levels of confidence as established by the searching party.

The method of searching may include as a foundational element the establishment of a preference data base to store preferences of users of the method. Each user of a system on which the method is resident may input identifying data for one or more categorized businesses. The inputs of each user are associated with an identification of the user. The inputting of the business into the data base constitutes a “vote” for the subject business. The method does not require scaling a user's degree of satisfaction with the businesses input by the user.

A searching party submits a general query to initiate a search. The query may include a category of business, keywords describing the searcher's needs or business names and a geographic location. The system selects candidate businesses based on this query.

The searching party may also designate a social filter to rank the results of the search. The social filter may include one or more designated users of the system, a group of users predefined by the searching party, or all users of the system. The number of “votes” found for a business within the selected social filter may establish its position in the ranked results. The system may also weight the “votes” of the users based on a degree of relationship between the user and the searching party, or on one or more characteristics of the users.

The results returned are then socially relevant to each user with choices that have a high probability of being personally relevant to the user. Users with personal preferences can therefore receive local search results that may be ranked differently from the results of another user with different personal preferences.

### BRIEF DESCRIPTION OF THE DRAWINGS

FIG. 1 is a schematic of the system of computer based searching using social graphs as filters.

FIG. 2 illustrates an exemplary method of searching utilizing social graphs as filters.

FIG. 3 illustrates a set of preference data associated with a user.

FIG. 4 illustrates a social graph for a user.

FIG. 5 illustrates the preference lists associated with a particular social graph.

FIG. 6 illustrates exemplary search information related to searching utilizing social graphs as filters.

FIG. 7 illustrates another example search.

FIG. 8 is a screenshot of an exemplary interface for providing a preference list used in the system.

FIG. 9 is a screenshot of an exemplary interface for providing a search result generated by the system.

FIG. 10 is a screenshot of an exemplary interface for providing a search result.

FIG. 11 is a screenshot of an exemplary interface for providing a search result.

FIG. 12 illustrates screenshots of an exemplary interface for providing a specific inquiry and a response to the inquiry.

FIG. 13 illustrates an exemplary computing system that may be used to implement an embodiment of the present invention.

### DETAILED DESCRIPTION

Various embodiments of the present invention use a method and system of computer based searching that returns results that are both geographically, socially and personally relevant. A searching party using the method may select a geographic area and a topic to be searched as in a typical search function, but searching only business entities that have been recommended by other users of the method. The search is performed on a data base created by users of the method who input preference data to a master relational index data base. The search party may then further filter the returned search results by considering the recommendations of one or more users identified by the searching party. The user may specify a level of confidence (trust) that he wants to apply to the search filter by designating a desired social graph or grouping within a social graph.

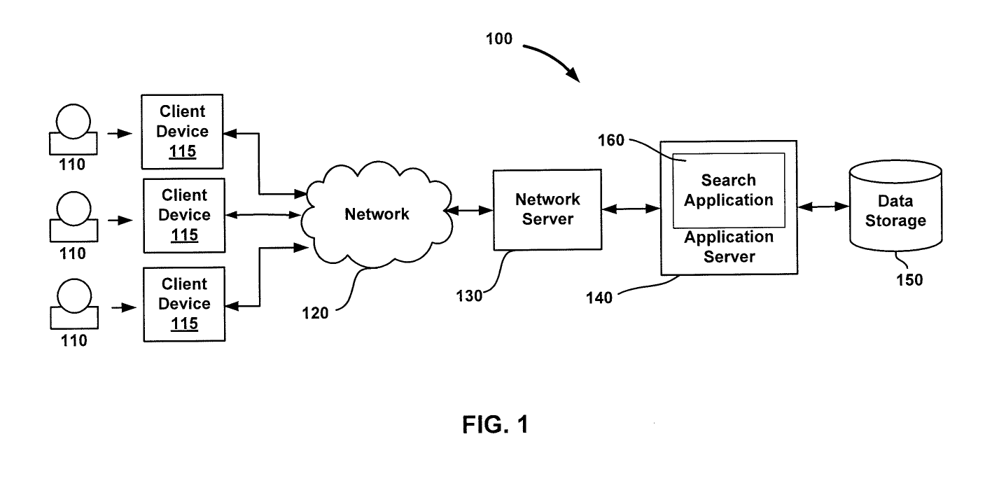

FIG. 1 shows an exemplary system 100 for implementing the method of the present invention. The system 100 of FIG. 1 includes a plurality of users 110 which may interact with client devices 115 in communication with a network 120. The network 120 includes a network server 130, an application server 140, and data storage 150. The search application 160 may reside and be executed by a processor on application server 140 to perform searching utilizing social graphs as filters.

Users 110 access network server 130, application server 140 and data storage 150 via client devices 115, such as for example workstations, servers, lap top computers, mobile devices, or other computing devices that can communicate over the network 120 using a browser application.

Network server 130 may be implemented as one or more machines that communicate over network 120 and communicate with application server 140. Application server 140 may communicate with network server 130 and host one or more applications or software modules which may be executed to implement the present technology. Data storage 150 may accessed by application server 140 (for example, through a query initiated by search application 160) and be implemented as one or more remote servers or within application server 140.

Network 120 may be implemented as any type of communication network including but not limited to the Internet, Wide Area Network (WAN), Local Area Network (LAN), intranet, extranet, private network, or other network. Application server 140 may be accessed via network server 130.

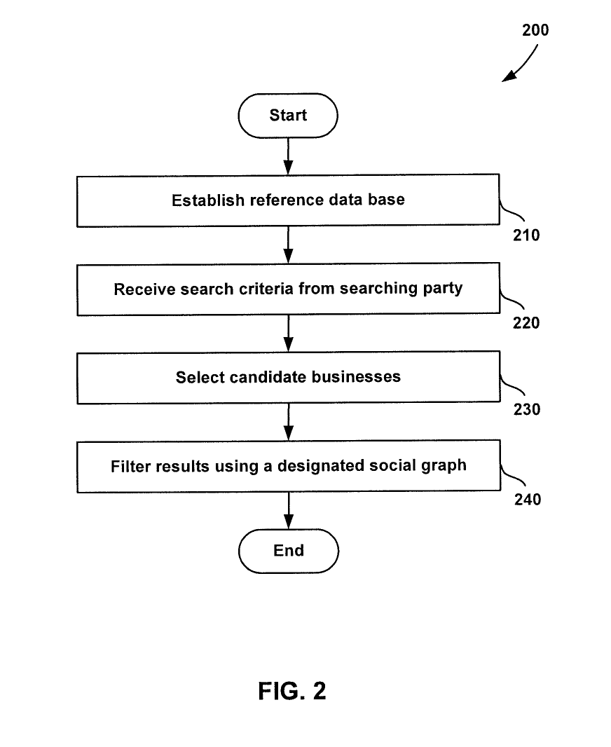

FIG. 2 is a flowchart of an exemplary method 200 for searching utilizing a social graph as a filter. In some embodiments, the method 200 may be performed by search application 160 residing on application server 140. An element of the method is the establishment of a preference data base at step 210. The preference data base includes preference entries created by the users of the system 100.

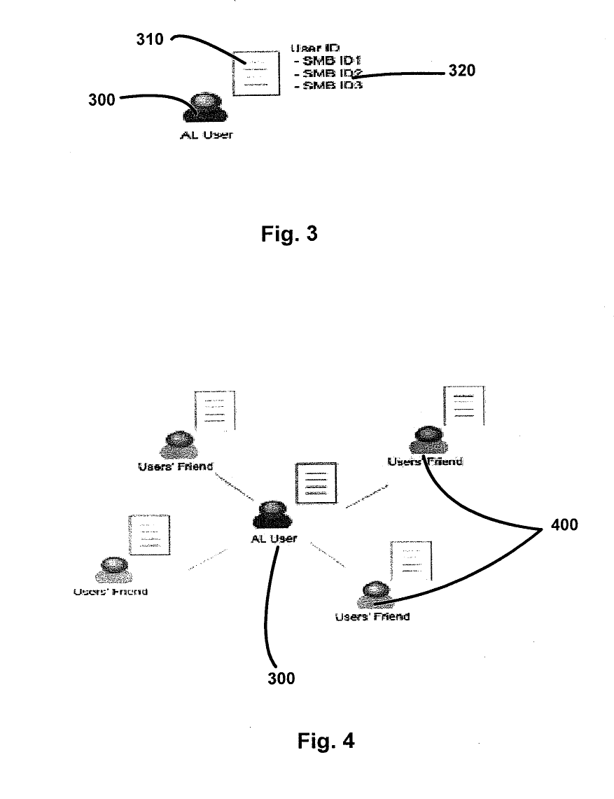

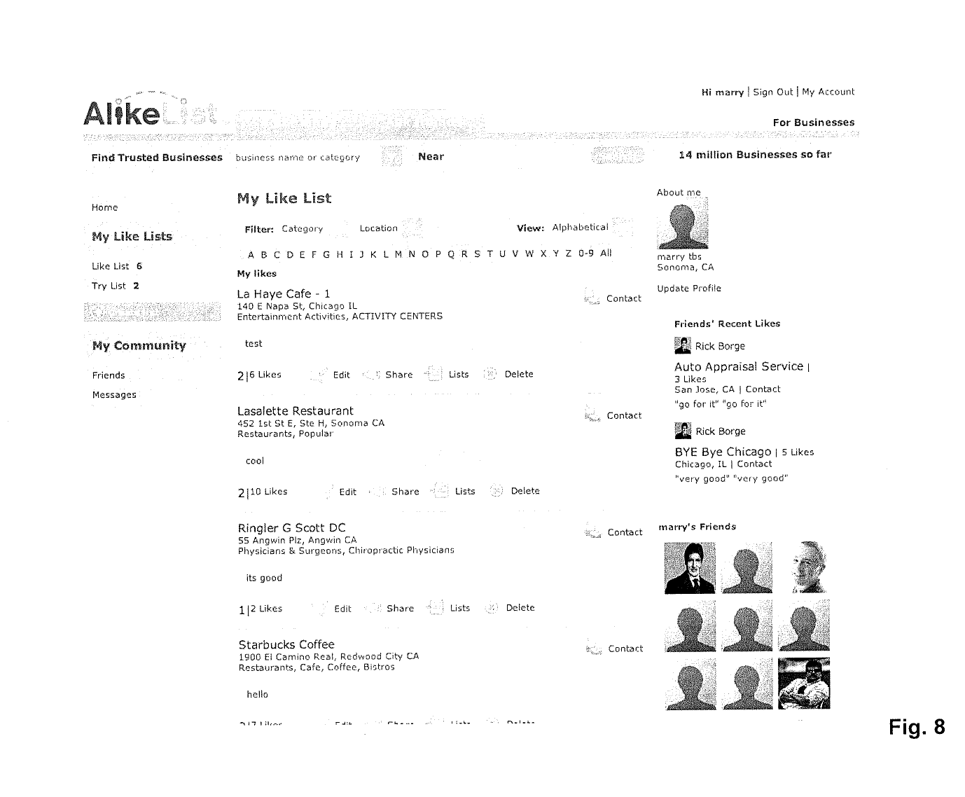

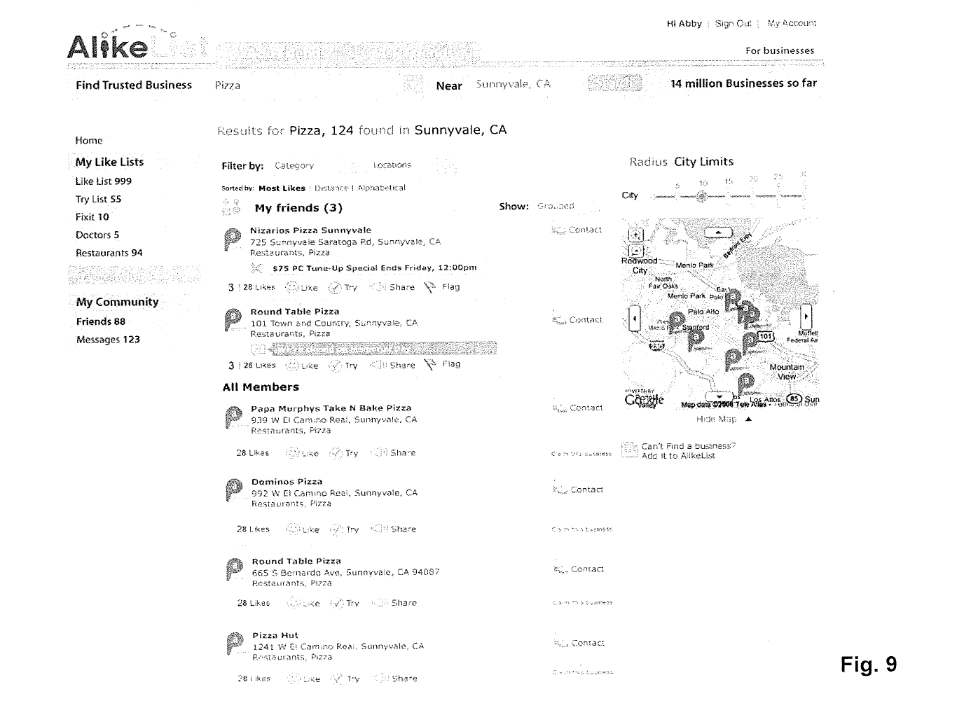

FIG. 3 illustrates a set of preference data associated with a user. As illustrated in FIG. 3, a user 300 may establish his preference data by inputting a preference list 310 with the names of one or more small to medium size businesses (SMB) through an interface provided by client device 115. Client device 115 may then transmit the preference data to application server 140 via network server 130. Application server 140 may store the preference data locally or store the data at data storage 150. FIG. 8 is a screenshot of an example interface provided by client device 115 for managing a preference list 310.

A search criterion or criteria may be received from a searching party at step 220. The searching criteria may be received by search application 160 on application server 140. Candidate businesses may then be selected at step 230. Search application 160 may select the candidate businesses by sending a query to data storage 150 with the search criteria received at step 220. Data storage 150 may then provide to search application 160 a list of candidate businesses that match the search criteria.

The resulting candidate businesses may be filtered using a designated social graph at step 240. By filtering the results, a subset of candidate businesses may be identified and provided to the searching party from which the search criteria were received at step 220.

The steps of method 200 are discussed in more detail below. Generally speaking, search application 160 may provide interfaces to one or more client devices 115. A user 110 may provide input into an interface through client device 115. Client device 115 may communicate with search application 160 on application server 140 to exchange the input and other data, such as for example search criteria, candidate businesses, filtered results. Application server 140 may receive data from client device 150 (via network 120 and network server 130) and process the data locally, as well as store the data at data storage 150 or locally to application server 140.

To populate an interface with data, such as candidate businesses, search application 160 may query data storage 150 for data that meets specific criteria. Data storage 150 may provide the requested data to search application 160 which may then provide the data to client device 115 through one or more interfaces.

Returning to FIG. 3, each user 300 (e.g., user 110 in FIG. 1) of the system 100 may input various business entities that the user 300 wants to have associated with their name. An identifying profile 320 (ID) is associated with each business entered by the user 300. The identifying profile 320 may include the business name, a category, and a location. Each identifying profile 320 may also be associated with the user 300 who input the preference data. Therefore each identifying profile 320 may include a business name, category, and location, and is associated with the user 300 who input the preference “vote” for the subject business.

In the method 200 of the present invention, there is no requirement that a rating scale be associated with the entry of a business into the preference data base. The user may simply submit an entry, such as for example a vote, if he likes the business; he does not submit an entry if he does not like the business. The preference data base listings may therefore be properly characterized as including only positive references to each business included in the listings.

Each preference list 310 may include one or more user votes or “human citations” for a business entity that the user wants to endorse. The user votes may be collected and maintained via a master relational index which may be stored on data storage 150 and continuously updated. The master index may be used in real-time to rank, by preference as established by the selected social graph, identified businesses. A listing of businesses is generated, using the ranking, in response to a specific user's search query. The listing returned for the query will thus be tailored to the user's specific social graph selected at the time of their search. The listing may include multiple levels of recommendation.

FIG. 4 illustrates a social graph for a user 300. A first user, a searching party 300, identifies one or more other users that are labeled friends 400. In the social graph illustrated in FIG. 3, the searching party has identified a social graph including four friends 400. Each of the friends 400 has only a single degree of separation from the searching party 300. The user in this exemplary embodiment might specify that his search used preferences from friends 400 only.

Each of the friends 400 may also have a social graph with one or more other users designated as friends. Therefore the searching party 300 may choose to initiate a search with varying levels of confidence or trust. That is, the searching party 300 may perform a search based on the preference only of the friends 400 of the searching party. The searching party 300 may expand his trust level to include friends of his friends, friends of those friends, and so on until the searching party simply searches based on all users of the system 100.

Each search performed by a searching party 300 may therefore be subject to varying levels of trust as defined by degree of separation. For each searching party 300, the levels of trust, the degrees of separation, that are available for a given search may vary with the individual searching party 300. The number of degrees of separation available to the searching party 300 is defined by the number of relationships formed between the searching party 300 and other users of the system 100.

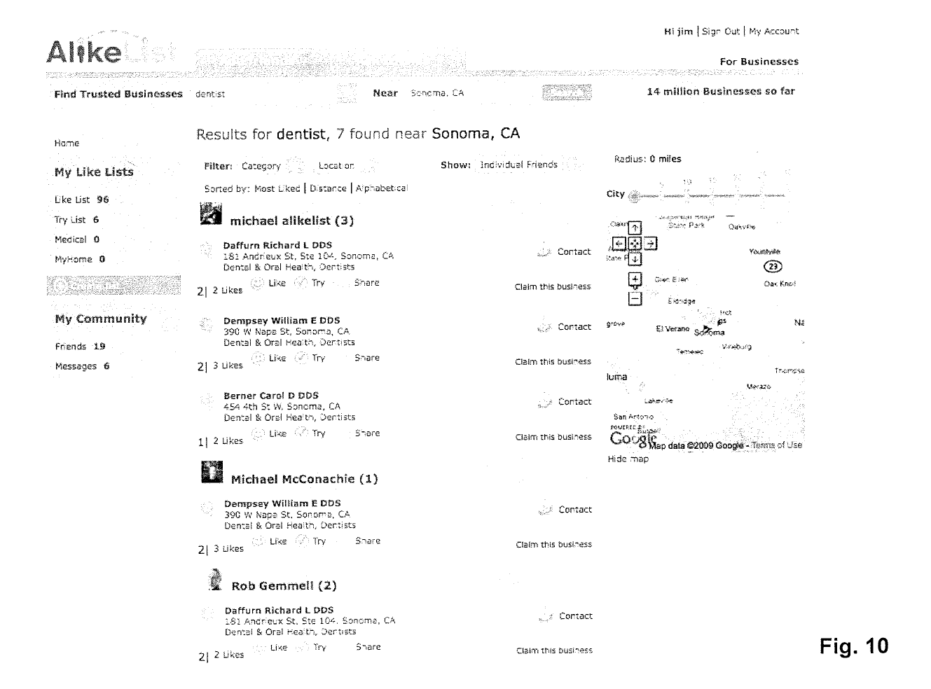

At the outset of each search, the searching party 300 may define a search filter with search criteria specifying a desired level of trust, i.e. the range of parties to be consulted. If the searching party 300 sets as his filter “friends” then the preference lists of only those users at a first degree of separation are considered. FIGS. 9 and 10 are screenshots of an exemplary interface for providing a search result generated by the system. In particular, the interface of FIG. 10 shows the results of a search performed at the “friends” level. If the searching party 300 sets the filter as “friends and friends of friends” then preferences of users up to a second degree of separation would be considered. The searching party 300 may also expand the social graph to include all users of the system 100. The interface of FIG. 9 shows the search results of an “all users” search. Note that even though the search is performed at the “all users” level, the results may be grouped to show the preferences of friends of the searching party being listed first.

In some instances, the searching party 300 might not find recommendations from his friends in the system 100. In this case, or at any time he so desires, the searching party 300 may choose to access a third party system to identify more friends. The new friend list created for the searching party 300 may then be used as a social graph defining a search filter in the system 100.

The searching party 300 may define the search filter to be any single friend 400. The searching party 300 may also define the social graph to be used as the search filter to be multiple or all friends 400. The social graph may also be a pre-specified grouping of friends, such as friends with an MBA, Book Club members, PTA members, etc.

For search decisions relating to a choice of business in which trust is paramount, such as finding a children's orthopedic specialist for a child's soccer injury or an in-home nanny, the user may select, through an interface provided on client device 115, very close friends and personal network members to form the social graph filter. For decisions in which trust and personal relevancy is not as important, or if the user is seeking to “discover” new businesses such as restaurants, the searching party (i.e., user) may choose to view and/or select recommendations from friends of friends or all members.

Each user of the system may expand his social graph either by associating with other established users of the system, or by recruiting his friends to also use the system. As the number of users at each level of trust relative to a searching party increases, so too does the likelihood of a successful search. A greater number of input preferences may be more likely to lead to results that meet the needs of the searching party 300.

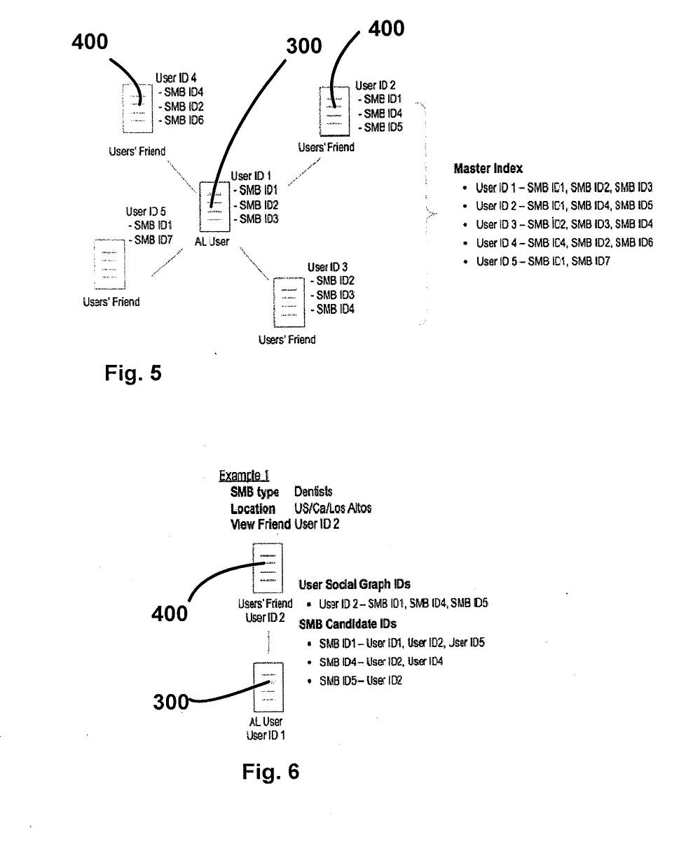

FIG. 5 illustrates the preference lists associated with a particular social graph. In particular, FIG. 5 shows the information that would be considered in a search using the social graph of FIG. 4. The searching party 300 in this instance has specified his search field as friends. The information from the master index that may be considered by the method includes the identification and preference information of the searching party 300 as well as the identification and preferences of the four other users identified as friends 400.

When a searching party 300 conducts a search, the social graph that is to be used as a filter may be either a predetermined default graph that is established by the system 100. Alternatively, the searching party 300 may manually enter his selected social graph. The social graph may be as simple as one selected friend 400, or it may be a group of friends 400. The social graph applied may be any specified group such as “all friends”, “friends-of-friends”, or the more broad “all members”.

In the master index, various business entities are associated with each user of the system 100. When a search is initiated by a searching party 300, the entities associated with those users selected to be in the social graph filter are returned as an initial list of candidates, and remain associated with a user.

The social graph used for the search is then applied to count the votes of the users specified in the social graph. This plurality recommendation may be coupled with topical matching and proximity matching algorithms to rank the candidate entities. The resultant ranked listing is returned to the searching party as the end result of the search. The end result listing is therefore a listing of those business entities with the highest relevancy to the specified social graph of the searching party 300. The entities with the highest topical and geographical relevancy may be listed first. Candidate entities with a second level of personal-social, topical, and geographic relevancy may be listed in a second results band. Additional bands of results based on expanded degrees of the applied social graph may also be listed.

FIG. 6 illustrates exemplary search information related to searching utilizing social graphs as filters. In particular, example 1 of FIG. 6 illustrates search criteria operated on by search application 160 and representative search result information (candidate businesses) received as a result of a query based on the search criteria. Example 1 assumes a searching party 300 associated with a User ID 1 is searching for a dentist in Los Altos, Calif. Hence, the search criteria may include “dentist” or “dental health” and “Los Altos” and “California.” In this example, the initial search specified by the searching party 300, User ID 1, is for a specific friend 400, User ID 2. The system selects as candidates those business entities associated with the friend 400, User ID 2 in the dental health category in the master index. In Example 1, those businesses are identified as SMB ID1, SMB ID4, and SMB ID5.

The candidate businesses may then be ranked according to the number of occurrences within a social graph specified by the searching party 300, which in this example includes the friends of the searching party 300. The first candidate business, SMB ID1, appears on the preference list of three friends in the social graph. The second candidate business, SMB ID4, is listed by two friends. The third candidate business, SMB ID5, appears on only one preference list in the social graph. The results list returned to the searching party 300 therefore shows SMB ID1 with a vote count of three in the first position. SMB ID4 with a vote count of two is second, and SMB ID5 is listed third.

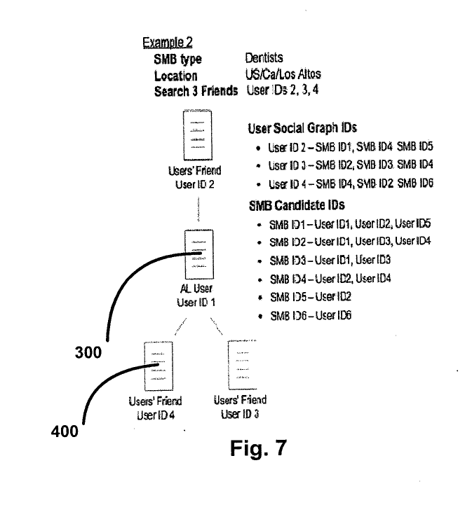

FIG. 7 illustrates exemplary search information related to searching utilizing social graphs as filters. Example 2 of FIG. 7 illustrates a search in which the system 100 may access the preference lists of three friends 400 to provide a candidates list of six businesses. As in Example 1, the candidate businesses are ranked according to the number of appearances in the preference lists of the users included in a specified social graph. However in Example 2, two businesses, SMB ID1 and SMB ID2, are tied for the first position since both have a vote count of three. A user may choose to have the system implement any of a plurality of ranking priorities, or tie breakers.

One way in which the system may establish ranking priorities is to use geographical proximity to the searching party. Another potential source of ranking weighting is the degree of matching between the search input and the products and services of the candidate business, that is, the availability of specific goods or services may be a factor in the ranking of the candidate businesses. Still another potential method of ranking weighting is the affinity of the searching party to the friends on whose lists the candidate business appears. Affinity may be determined by degree of separation, number of times the preference list has been accessed, or other factors that may be chosen by the user or established by the system.

In example 2, if the friends 400 with User ID3 and User ID4 are more closely related to the searching party than are friends 400 with User ID2 and User ID5, then SMB ID2 would appear first on the results list. In example 2, a ranking priority may also be used to establish third place between SMB ID3 and SMB ID4 with each having two social graph votes, and fifth place would similarly be determined by a selected method of ranking priority between SMB ID5 and SMB ID6.

Various attributes of users within the social graph may be used to drive the priority ranking of the preference lists of users within the social graph filter. For example, the preference list of a user whose profile lists their home location as Sonoma, Calif., might be accessed to recommend businesses in Sonoma in response to a search. The preferences of the Sonoma user would receive additional weighting, as compared to a non-Sonoma resident member of the social graph, due to the fact that the Sonoma user is a Sonoma resident. Similarly, if a specific friend in a specified social graph lists more golf courses than any of the other selected friends in the social graph filter for a given search, the golf course preferences of the specific friend may be given greater weight in the ranking process.

Preference list weighting may also be established on the basis of the experiences evidenced by the profile of a user. If a member of a specified social graph is employed in the industry of the desired search topic, the “reputation” of that member as an industry professional may be factored into the ranking. The professions of users of the system may be meta-tagged in the system database. So in the case of a searching party looking for an orthopedic doctor, the recommendation of the social graph member (via his preference list) whose profile indicates that he is an “orthopedic research engineer” may weigh more heavily than other members of the social graph as defined by the searching party.

The historical activity between a searching party and the various users included in a specified social graph may also be used to establish weighted priorities. More activity between a searching party and a first friend might indicate a higher affinity between the searching party and the first friend as compared to the affinity of the searching party to a second friend who is accessed less. Preferences of the first friend would be weighed more heavily than those of the second friend. “Activity” between two users of the system may include clicking on a profile, asking for a recommendation, viewing a preference list, recommending the other user, and other activities that may be utilized within the system.

A user of the system who receives the most “asks” or who has the most friends adding businesses recommended from their preference list may be labeled as an expert for the purposes of a social graph. The preferences of the expert may be given added weighting, thereby affecting the document rankings of searching parties that include the user designated as an expert in their social graph.

Another factor that may be used to prioritize preference lists is identifying users with specific characteristics that may add value to their preferences. One such characteristic is residence. A searching party may choose to give additional weight to the preferences of users local to an area of search. A “local” user may be defined as a user having the same residence as the locality that is the target of the search enquiry, or a user residing within a specified distance from that locality. Users falling within the residence category may or may not have any connection to the searching party. The effect of this prioritization would be that a searching party looking, for instance, for a restaurant in a given city might give additional weight to the preferences listed by users resident in that city.

Group affiliations may also be used as a ranking prioritization factor. Memberships and other designations listed in the user profiles, regardless of whether the user is in a specified social graph. Social graphs and group affiliations may be used in combination to provide prioritized ranking results. For example, a searching party looking for an accountant might specify as their social graph those users who hold an MBA degree. A first level of search results might therefore include accountants listed by MBA holders whose user profile indicates they went to the same school as the searching party. A second level of results under these search criteria might include accountants recommended by MBA holders who are friends of the MBAs who are friends of the searching party. A third level of search results might include accountant recommendations from all users who are MBA holders.

Self-learning matching algorithms may also be included in the system 100 and method 200 to further refine ranking priorities. Using matching algorithms, the method may use characteristics of users across social graphs to recommend preferences from users not included in the specified social graph. The recommendations may be made if the characteristics of the user outside the social graph are such that they create a high degree of confidence in the relevance of the recommended preferences to the searching party. Using the matching algorithms, the system may implement collaborative filtering. For example, if the profile of a second user has a strong correlation to the profile of a searching party, the preferences of the second user may be utilized in a search initiated by the searching party. This matching may occur whether or not the second user is included in the social graph specified by the searching party.

The present technology may further use attributes and classifications of the preference lists of the users to cross reference users with similar attributes. The system may use the cross referencing information to quickly search, rank, and sort for a first user the information input by users with similar attributes.

Category links allow a first user to access the preferences of a second user in a given category. The category links may typically be used to access the preferences list of a user who may have a substantial number of entries in the given category.

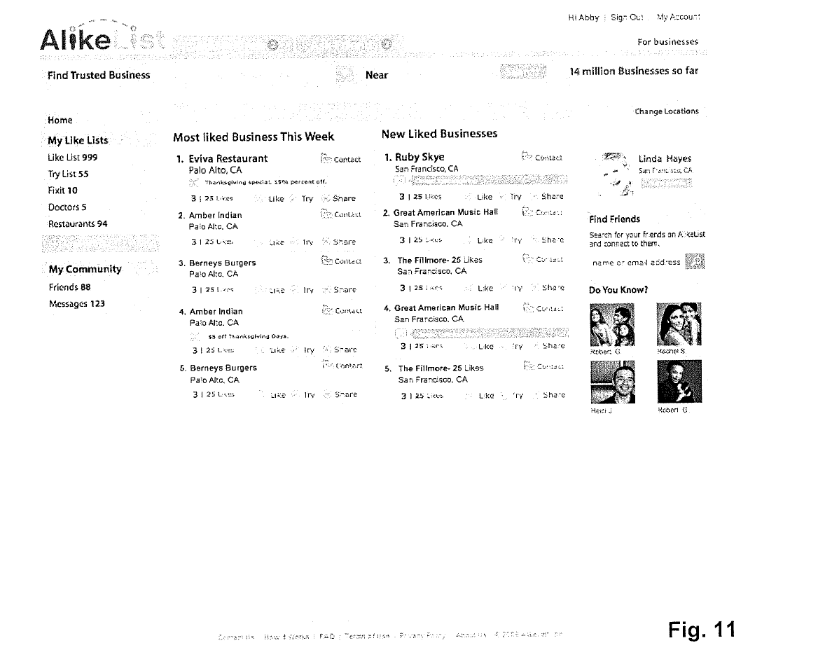

The system 100 may also be used to track the activity of the users. FIG. 11 shows an exemplary interface for providing a search result. In particular, the interface of FIG. 11 shows the results that might be returned for a search for the most accessed businesses (first column) in a given time period. The system 100 may also be queried as to newly entered businesses (second column), those businesses first appearing in the system 100 in the specified time period.

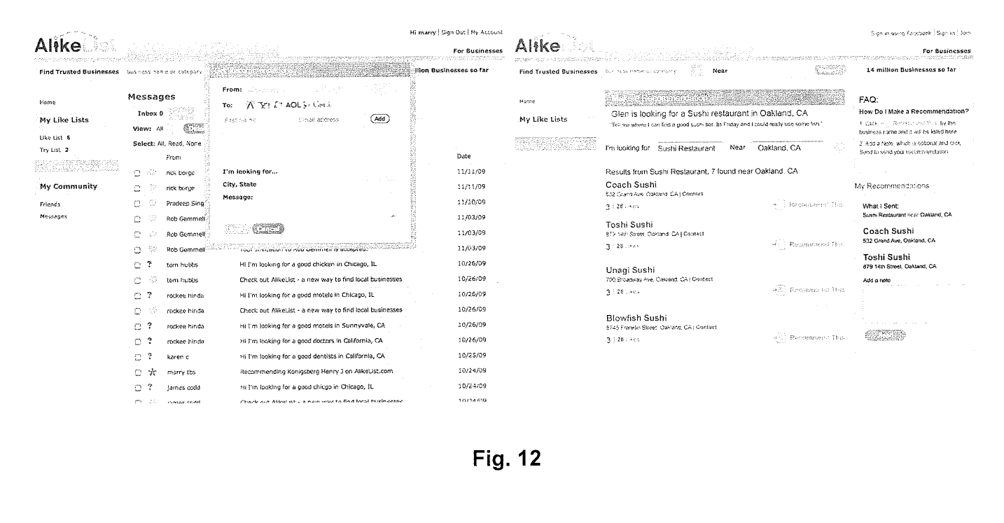

A searching party may also query the system for a direct recommendation, an “Ask”. FIG. 12 illustrates exemplary interfaces for providing a specific inquiry and a response to the inquiry. In particular, the interfaces of FIG. 12 depict the generation of a specific request (the “Ask”, left screen), and the list that might be returned (the “Ask Response”, right screen). The “Ask” function may be particularly useful when a search has found no information available in the preference data base for the requested search target. The “Ask” may be targeted to one or more specific users selected by the searching party, or to all users. Any group predefined by the searching party may be the target of the “Ask”.

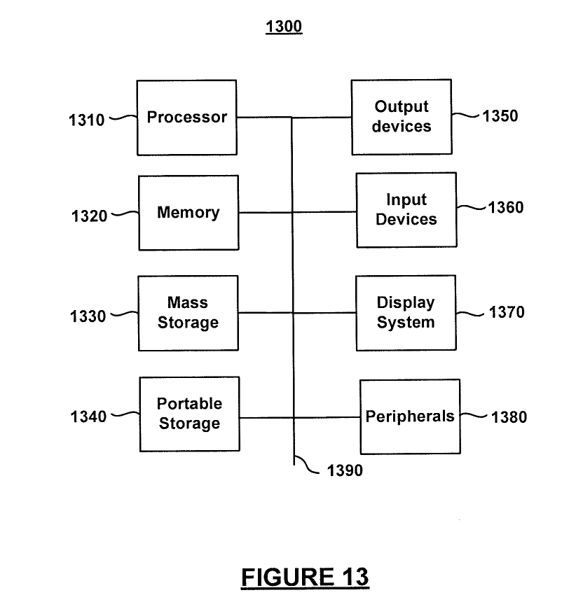

FIG. 13 illustrates an exemplary computing system 1300 that may be used to implement an embodiment of the present invention. System 1300 of FIG. 13 may be implemented in the contexts of the likes of client devices 115, network server 130, application server 140, and data storage 150. The computing system 1300 of FIG. 13 includes one or more processors 1310 and memory 1320. Main memory 1320 stores, in part, instructions and data for execution by processor 1310. Main memory 1320 can store the executable code when in operation. The system 1300 of FIG. 13 further includes a mass storage device 1330, portable storage medium drive(s) 1340, output devices 1350, user input devices 1360, a graphics display 1370, and peripheral devices 1380.

The components shown in FIG. 13 are depicted as being connected via a single bus 1390. The components may be connected through one or more data transport means. Processor unit 1310 and main memory 1320 may be connected via a local microprocessor bus, and the mass storage device 1330, peripheral device(s) 1380, portable storage device 1340, and display system 1370 may be connected via one or more input/output (I/O) buses.

Mass storage device 1330, which may be implemented with a magnetic disk drive or an optical disk drive, is a non-volatile storage device for storing data and instructions for use by processor unit 1310. Mass storage device 1330 can store the system software for implementing embodiments of the present invention for purposes of loading that software into main memory 1320.

Portable storage device 1340 operates in conjunction with a portable non-volatile storage medium, such as a floppy disk, compact disk or Digital video disc, to input and output data and code to and from the computer system 1300 of FIG. 13. The system software for implementing embodiments of the present invention may be stored on such a portable medium and input to the computer system 1300 via the portable storage device 1340.

Input devices 1360 provide a portion of a user interface. Input devices 1360 may include an alpha-numeric keypad, such as a keyboard, for inputting alpha-numeric and other information, or a pointing device, such as a mouse, a trackball, stylus, or cursor direction keys. Additionally, the system 1300 as shown in FIG. 13 includes output devices 1350. Suitable output devices include speakers, printers, network interfaces, and monitors.

Display system 1370 may include a liquid crystal display (LCD) or other suitable display device. Display system 1370 receives textual and graphical information, and processes the information for output to the display device.

Peripherals 1380 may include any type of computer support device to add additional functionality to the computer system. Peripheral device(s) 1380 may include a modem or a router.

The components contained in the computer system 1300 of FIG. 13 are those typically found in computer systems that may be suitable for use with embodiments of the present invention and are intended to represent a broad category of such computer components that are well known in the art. Thus, the computer system 1300 of FIG. 13 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The embodiments described herein are illustrative of the present invention. As these embodiments of the present invention are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method of computer based searching, the method comprising:
establishing a preference data base by an application stored on a server and executed by a processor, the preference data base including preference data for one or more users;
receiving one or more search criteria from a searching party;
selecting candidate businesses from the preference data base based on a correlation between the search criteria and identifying data stored in the preference data base and associated with the candidate businesses; and
filtering the candidate businesses using criteria designated by the searching party.

2. The method of claim 1, wherein filtering the candidate businesses includes designating a social graph that includes at least one of the one or more users, preferences of the at least one of the one or more users included in the social graph being used to rank the candidate businesses.

3. The method of claim 1, wherein filtering the candidate businesses includes designating a social graph that includes a group of users predefined by the searching party, preferences of the group of users included in the social graph being used to rank the candidate businesses.

4. The method of claim 3, wherein designating a social graph includes selecting users according to a degree of relation to the searching party.

5. The method of claim 3, wherein designating a social graph includes selecting users according to one or more characteristics of the users.

6. The method of claim 2, wherein designating a social graph includes weighting the preferences of the users designated by the searching party.

7. The method of claim 6, wherein weighting the preferences includes considering a degree of relationship between the searching party and the user that established the preference, the weighting being proportional to the degree of relationship.

8. The method of claim 6, wherein weighting the preferences includes considering characteristics of the users that established the preferences.

9. The method of claim 2, wherein designating a social graph includes importing data from a third party service.

10. The method of claim 1, further comprising storing information input by users in a storage medium accessible by the application.

11. The method of claim 10, wherein storing information includes storing preferences of one or more users.

12. A system for computer based searching, the system comprising:
a memory device including a data base configured to store entries relative to one or more businesses, each of the entries including identifying data for one of the businesses, and each entry being associated with a user of the system; and
a processor configured to execute instructions stored in memory to:
establish a preference data base to store preferences of users of the system,
receive one or more search criteria from a searching party,
select candidate businesses from the preference data base based on a correlation between identifying data associated with the candidate businesses and the search criteria, and
filter the candidate businesses using criteria designated by the searching party.

13. The system of claim 12, wherein the processor filters the candidate businesses using a social graph designated by the searching party, the social graph including one or more users of the system, preferences of the users included in the social graph being used to rank the candidate businesses.

14. The system of claim 12, wherein the processor filters the candidate businesses using a social graph designated by the searching party, the social graph including a group of users predefined by the searching party, preferences of the group of users included in the social graph being used to rank the candidate businesses.

15. The system of claim 14, wherein the social graph includes users selected according to a degree of relation to the searching party.

16. The system of claim 14, wherein the social graph includes users selected according to one or more characteristics of the users.

17. The system of claim 13, wherein preferences of the users in the social graph are variably weighted.

18. The system of claim 17, wherein preferences of the users in the social graph are weighted according to a degree of relationship between the searching party and the user that established the preference.

19. The system of claim 17, wherein preferences of the users in the social graph are weighted according to characteristics of the users that established the preferences.

20. The system of claim 12, further comprising a web-based storage medium to store information input by users of the system.

21. The system of claim 20, wherein the stored information includes preferences of one or more users.

22. The system of claim 12, wherein the processor filters the candidate businesses using a social graph designated by the searching party, the social graph including entities chosen from a third party service.
